(19) United States
(12) Patent Application Publication
(10) Pub. No.: US 2003/0106845 A1
(43) Pub. Date: Jun. 12, 2003

(54) Automatic device for purifying drinking water

(76) Inventors: Michel Bernard, Montigny Le Bretonneux (FR); Alain Fahrasmane, Bouglainval (FR)

Correspondence Address: William A Drucker, 1299 Pennsylvania Avenue NW, Washington, DC, 20004, US

(21) Appl. No.: 10/168,128

(22) PCT Filed: Dec. 26, 2000
(86) PCT No.: PCT/FR00/03682

(30) Foreign Application Priority Data
Jan. 3, 2000 (FR) 00/00098

(51) Int. Cl. C02F 1/469

(52) U.S. Cl. 210/97; 210/243; 210/266; 210/321.6

(57) ABSTRACT

The inventive device comprises an electrodialysis unit (5) comprising the following: two electrodes (37, 37′) for generating a continuous electric field between them and, between the electrodes, a plurality of ion-exchanger membranes (44, 45) which select of positive or negative ions (45), a plurality of membrane separator frames (41), each of which is arranged between two membranes (44, 45) so that the water to be treated can pass over the surface of the adjacent membranes, and two separator frames (40) for separating the electrodes and the membranes, which are arranged between the two electrodes (37, 37′) and the adjacent membranes (44) to allow the water to pass along the electrodes, the water to be treated only being guided into the separator frames (41) between two ion exchange membranes and the purified water being guided into the frames (40) separating the electrodes and the membranes, before being guided to the exit (33) of the electrodialysis unit.

The present invention concerns a device for purifying drinking water.

It can be applied in particular, but not exclusively, to the purification of distributed drinking water for domestic or public consumption with a capacity of between several litres and several cubic litres per day.

Despite the implementation of a purification and treatment process, the distributed drinking water may still contain polluting elements which induce relatively harmful effects in terms of appearance (suspended materials), odour and taste (chlorine, organic compounds), health (presence of bacteria, limestone, nitrates, pesticides, organic compounds, heavy metals, etc).

Thus, it is preferable to purify the distributed drinking water by reducing the polluting elements it contains whilst retaining its natural trace elements.

There exist devices for domestic usage which eliminate all or part of the compounds in question, such as pollutants. The most up-to-date devices are applied after the water tapping cock and are constituted by absorbing and/or filtering elements making the water undergo two or three treatment stages. However, these devices only eliminate one portion of the polluting elements, and in certain cases, they can even transmit pollution when they are used in poor conditions, especially conditions relating to flow, waterlogging or temperature.

Other known devices are applied before the water tapping cock, and are based on a on a filtering system by inverse osmosis which can be associated with a pre-treatment using the filtering and absorbing elements and possibly a filtration, sterilisation and remineralization post-treatment. These devices make it possible to eliminate the major part of elements considered as being pollutants. However, they have the following drawbacks

implementing a large number of treatment stages (5 to 6 stages),

producing an almost chemically pure water without mineral salts, which makes it necessary to implement a remineralization post-treatment stage,

having to first soften and dechlorinate the water to be treated which makes it necessary to implement a disinfection post-treatment stage, and

having a low efficiency, namely of ⅕th to 1/20th of the treated water with respect to the consumed water.

The electrodialysis method is moreover known and used in high-capacity industrial applications for purifying solutions and demineralizing or desalting water. This method consists of applying a continuous electric field to the aqueous solution to be treated so as to obtain the migration of the ionised species contained in the solution. Separating the pollutant ionic species from the pure solution is carried out by using:

ions exchanger membranes, some being selective from cations and others from anions, the ionic selectivity of these membranes able to be adapted to extracting species with plurivalent and/or monovalent ionic charges, and

separators making the water to be treated circulate on the surfaces of the exchanger membranes.

It is proved that in this method, the electrodes generating the electric field and the membranes tend to choke, and the alkaline earth cations tend to precipitate on the cathode and on the selective membranes of the anions. Moreover, said method is ill-adapted to be implemented in a small treatment unit, as such miniaturization involves a reduction of the water passage pipes in the various elements of the electrodialysis unit and thus there is an increased risk of choking and blocking of said pipes.

The purpose of the present invention is overcome these drawbacks. With this end in view, the invention offers a device for purifying water for domestic or public consumption, said device comprising an electrodialysis unit including:

two flat electrodes placed opposite each other which are submitted to a d.c. voltage so as to generate a continuous electric field between them,

a plurality of ions exchanger membranes placed between the electrodes, amongst which some being selective of positive ions and some of negative ions, and

a plurality of membrane separator frames each placed between two adjacent ion exchanger membranes and allowing the passage of the water to be treated on the surface of said two membranes,

two electrode and membrane separator frames placed respectively between the two electrodes and the adjacent ion exchanger membranes and allowing passage of the water along the electrodes,

a pipe for supplying the water to be treated in the separator frames and two respective pipes for extracting brackish water and purified water from the separator frames.

According to the invention, said device is characterised in that the electrodialysis unit includes means for sending the water to be treated exclusively into the separator frames between the two ion exchanger membranes and means for sending the purified water of the purified water extracting pipe into the electrode and membrane separators before sending it to the outlet of the electrodialysis unit.

With the aid of these arrangements, by passing again onto the negative electrode, the purified water reduces the precipitation phenomenon which is very intense on said electrode owing to the very low acidity of the surrounding medium. Thus, the need for carrying out water softening pre-treatment is avoided if the water to be treated has a high percentage of limestone. Moreover, the layer of purified (less alkaline) water circulating on the surface of the electrodes, whose conductivity is all the more weaker when the ionic purification is high, procures a self-regulation effect of the d.c. current traversing the electrodialysis unit.

Moreover, it can be observed that by passing again onto the positive electrode, the purified water traverses a highly oxydizing medium which has a bactericide and bacteriostatic effect (the population of bacteria does not increase after the treatment). Thus, there is no need to carry out an antibacterial post-treatment.

By eliminating several treatment stages, the invention makes it possible to appreciably reduce the cost of a water purification device by applying the electrodialysis method. Thus, said method can be implemented in a small electric household device which is sufficiently low so as to be accessible to consumers.

According to one particular characteristic of the invention, the device includes means for inverting the polarity applied to the electrodes, means for periodically controlling the polarity inversion means so that the respective periods of positive polarisation alternances and negative polarisation alternances are equal, and/or d.c. current feed means, so that the amount of d.c. current delivered to the system during both the polarity alternances are equal, and electrovalve means switched at each alternance so as to direct the brackish water of the electrodialysis unit and the purified water in the electrode and membrane separator frames and then to the purified water outlet of the electrodialysis unit.

In this way, the ions which have precipitated in the electrodialysis unit during one alternance are dissolved during the following alternance owing to the polarity inversion which transforms into an acid medium the basic medium where the precipitations are produced.

The period of the alternances of polarity is between several minutes and several tens of minutes and preferably between two and ten minutes.

Advantageously, the equality of the duration of the alternances of polarity and quantities of d.c. current are obtained with a precision of less than +1% and preferably less than ±0.05%.

Thus, crushing of the electrodialysis unit is avoided in the long run.

A non-restrictive example of an embodiment of the device of the invention is described hereafter with reference to the accompanying drawings on which:

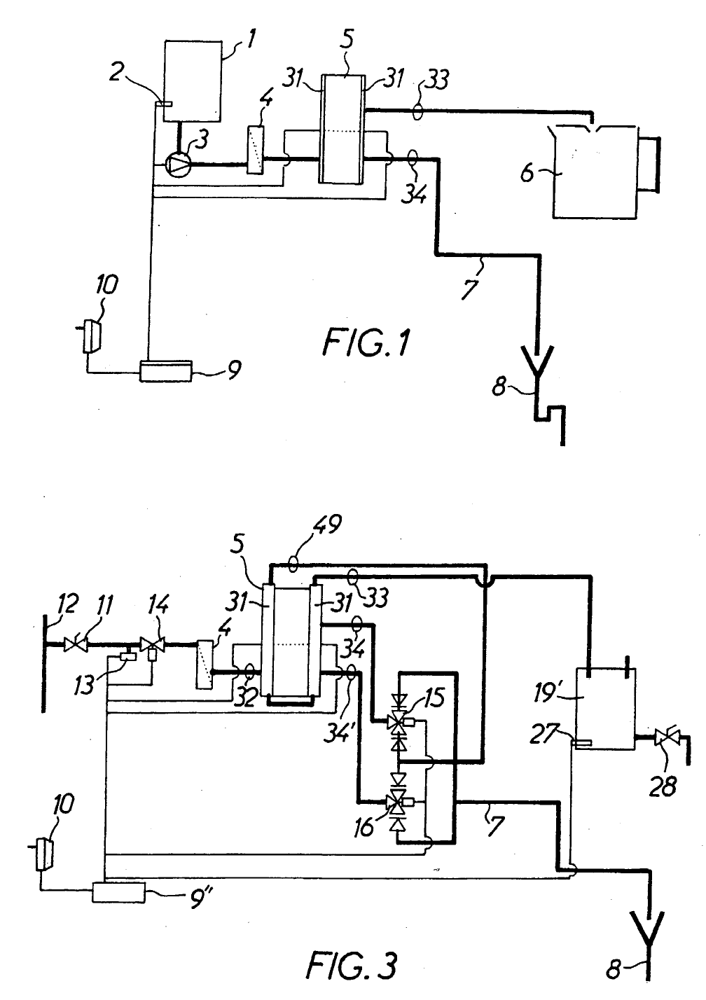

FIG. 1 is a skeleton diagram of a water purification device according to a first preferred embodiment variant of the invention;

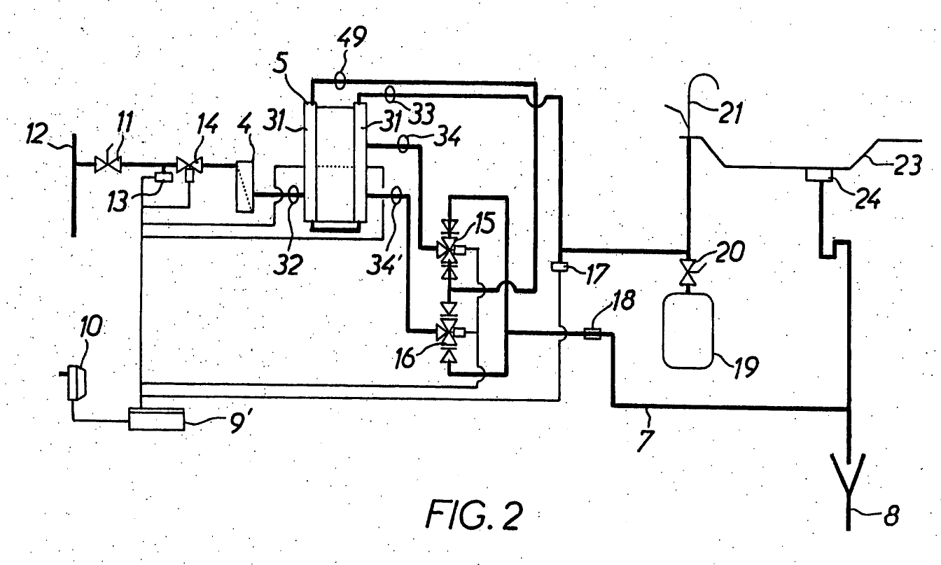

FIG. 2 is a skeleton diagram of a water purification device according to a second preferred embodiment variant of the invention

FIG. 3 is a skeleton diagram of a water purification device according to a preferred third embodiment variant of the invention;

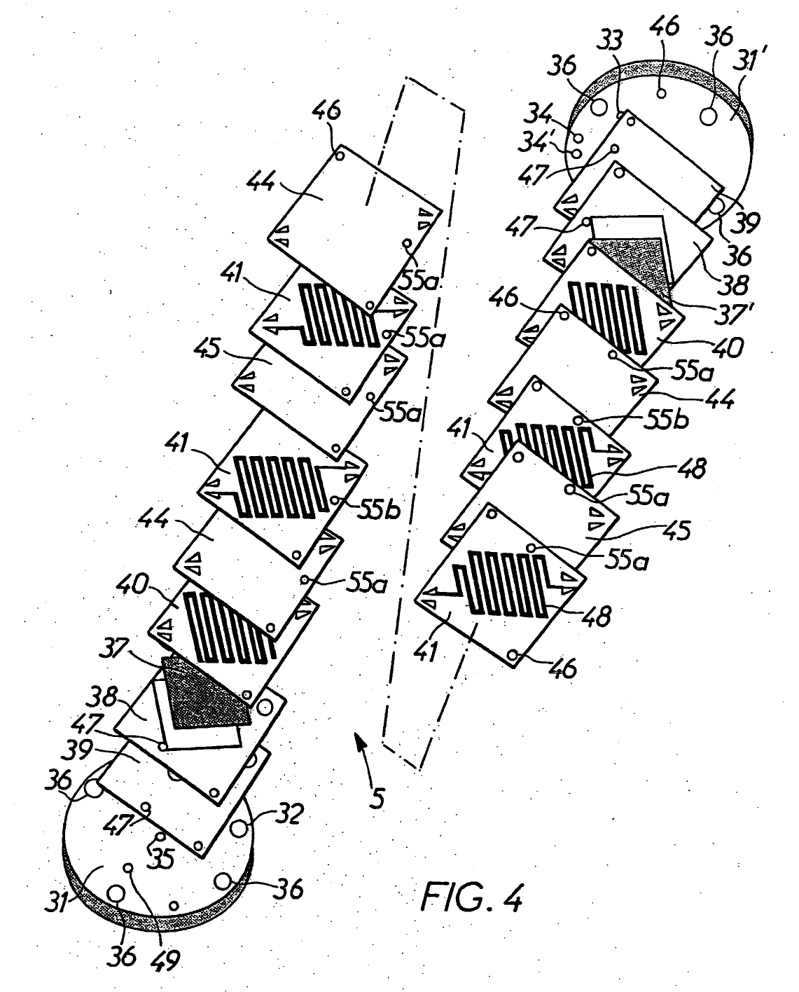

FIG. 4 is an exploded view of a preferred embodiment of an electrodialysis unit;

FIG. 5 diagrammatically illustrates the operating principle of the electrodialysis unit shown on FIG. 4.

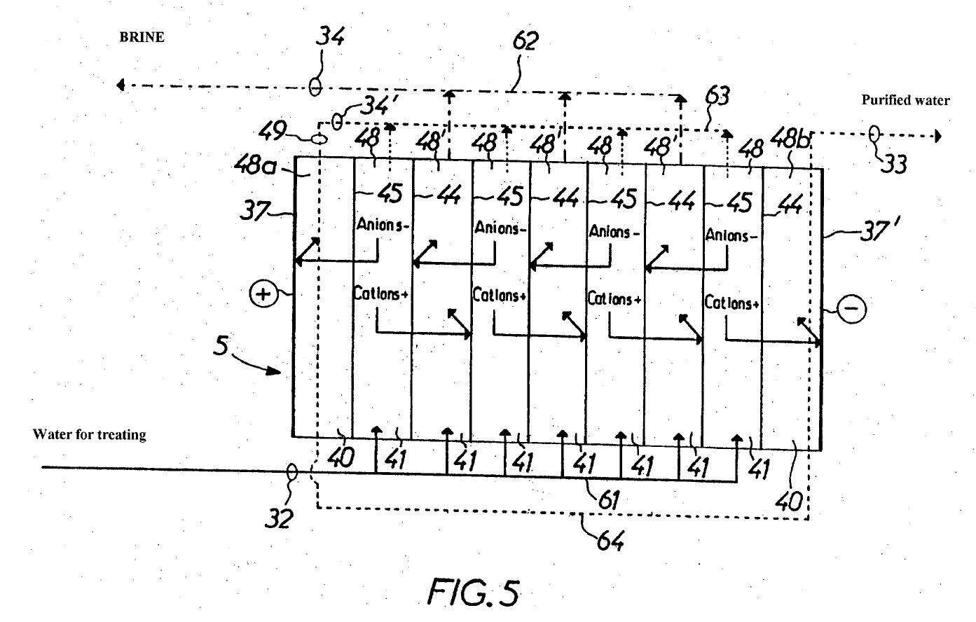

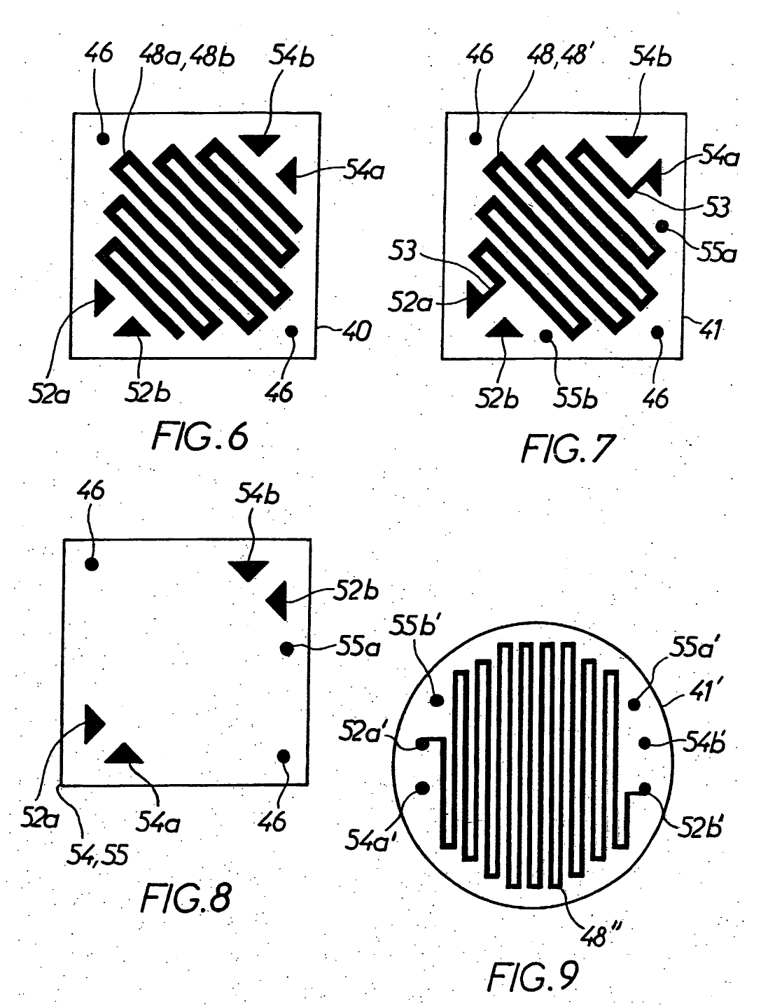

FIGS. 6, 7 and 8 show respectively in detail an electrode and membrane separator frame, a membrane separator frame and a membrane used in the electrodialysis unit shown on FIG. 4;

FIG. 9 shows in detail an embodiment variant of a membrane separator frame used in the electrodialysis unit shown on FIG. 4;

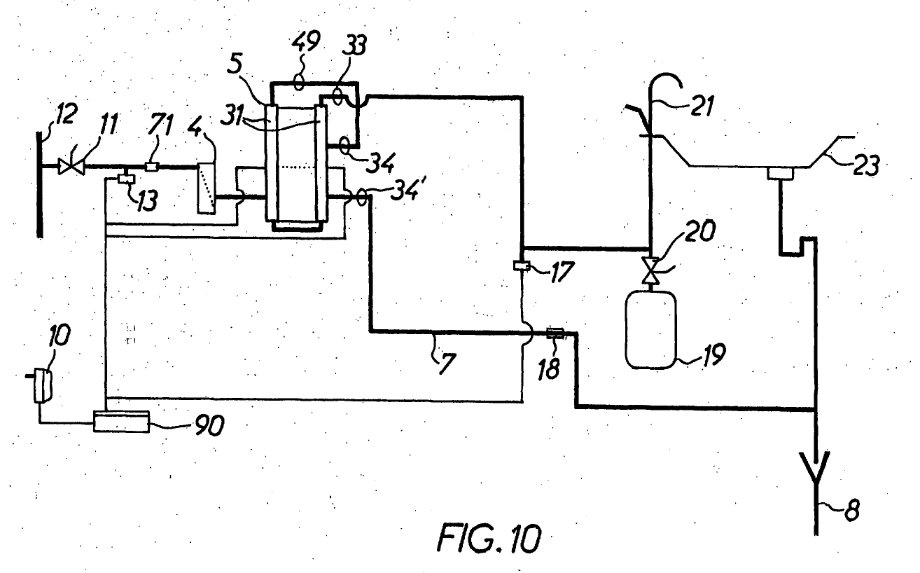

FIG. 10 is a skeleton diagram of a water purification device according to a fourth preferred embodiment variant of the invention.

The device of the invention shown on FIG. 1 consists of a small water purification unit for domestic usage and not connected to a drinking water distribution network. This device includes an electrodialysis unit 5 connected to a water tank 1 to be treated, and a pump 3 which injects water from the tank 1 into the electrodialysis unit 5. Depending on the quality of the water to be treated, it is possible to place a pretreatment unit 4 between the pump and the electrodialysis unit.

The electrodialysis unit 5 comprises an outlet 33 for the treated water which is collected in a tank 6 and a brackish water evacuation outlet 34 containing the pollutants extracted from the treated water and able to be connected via a pipe 7 to a waste water evacuation circuit 8. The tanks 1 and 6 are at atmospheric pressure, the tank 6 being constituted by a movable pitcher.

The pump 3 and the electrodialysis unit 5 are controlled and fed with electric energy by a control member 9, for example provided with a cord and a connection plug 10 to the electric network. The tank 1 comprises a water level detector 2 connected to the control member 9 which has been designed so as to stop the pump 3 and the electrodialysis unit 5 when the water level in the tank 1 is lower than a predetermined minimum threshold.

The pretreatment unit 4 may for example be constituted by an assembly of elements, such as filters adapted to the physico-chemical quality of the water to be treated.

Thus unit preferably includes an element for filtering sediment whose particles are larger than 5 μm so as to eliminate the suspended materials and the precipitated elements; an active carbon element in the form of granulates or a compacted block so as to eliminate pesticide pollutants, chlorinated compounds and organic materials, and a complexing agent, such as a sodium polyphosphate or sodium silicopolyphosphate-based element. These elements can be conditioned in the form of a cartridge fitted with inlet and outlet orifices to enable the water to be treated to circulate.

According to the invention, the electrodialysis unit 5 is able to eliminate from the water to be treated the excess ionic species, such as nitrates, phosphates, calcium, carbonates, etc. To this effect, it is of the multicellular type whose internal organisation is adapted to the purification of water for domestic usage, namely “town water”, without it being necessary to have this water undergo a prior softening treatment.

The control member 9 includes a voltage transformer, a current rectifier for feeding the electrodialysis unit, a pump command and control circuit and a set of luminous indicator lights indicating the state of the device.

This device is advantageously housed in a box similar to that of a small household appliance, the pitcher 6 for receiving the treated water being movable.

FIG. 2 shows a device according to the invention, said device being designed so as to be directly connected to an under pressure water distribution circuit and provide when required the under pressure treated water automatically. On, this figure, the purification device includes an electrodialysis unit 5 which can be associated with a pretreatment unit 4, this unit being fed with the water to be treated by the water distribution circuit 12 by means of a stop valve 11 and an electrovalve 14. The pressure of the water between the stop valve 11 and the electrovalve 14 is detected by a low pressure pressure detector 13. The electrodialysis unit 5 includes two outlets 34, 34′, namely one treated water outlet and one brackish water outlet, both outlets being connected to a two-channel double electrovalve unit 15, 16. At the outlet of this unit, there is a brackish water evacuation pipe 7 connected to the waste water evacuation circuit 8, and a pipe for supplying the treated water to a tapping cock 21, and, by means of a stop valve 20, to an under pressure storage tank 19. The pressure in the treated water circuit is detected by a pressure detector 17.

The set of electrovalves 14, 15, 16 is controlled by a control member 9′ according to indications provided by the detectors 13, 17. The control member 9′ is connected to the electric distribution network by means of a connection plug 10 and feeds the electrodialysis unit 5 with continuous voltage.

Located on the brackish water pipe, there is a flow limitation element 18 for limiting the brackish water flow, especially when the pressure of the water of the circuit gradually increases when the tank 19 is being filled.

The pressure detector 17 on the treated water pipe makes it possible to detect when the tank is full and when the cock 21 is closed so as to order the closing of the electrovalve 14 and the cutting off the electric feeding of the electrodialysis unit 5. A change of the sate of this pressure detector triggers the inverted order, namely opening of the electrovalve 14 and putting of the electrodialysis unit into operation.

When the cock 21 is activated, the treated water which is not consumed falls into a sink connected to the waste water evacuation network (8).

All the elements of this device are combined in a box whose rear face is equipped with passages and connectors required for electric and water feeding and for evacuation of the treated water and the brackish water. The front and/or top faces of this box are equipped with control and operating signalling elements.

FIG. 3 represents a simplified variant of the device shown on FIG. 2. The device shown on this figure is approximately identical to the one shown on FIG. 3, but here the treated water pipe is connected to a tank 19′ at atmospheric pressure, the outlet of this tank being connected to a treated water pick up valve 28. The water level of the tank 19′ is measured by a water level detector 27 connected to a control member 9″ which controls opening of the electrovalve 14 and starting the electrodialysis unit when the level of water detected by the detector 27 is below a certain predetermined minimum threshold and carried out an opposite order when this level goes above a certain maximum threshold.

As shown on FIG. 4, the electrodialysis unit 5 includes one or several treatment stages constituted by a stacking of layers including

external flanges 31, 31′ respectively comprising water inlet 32 and outlet orifices 33, 34 and orifices 35 for passage of the electric links for feeding the electrodes with direct current,

two electrodes 37, 37′ embodied embodied in a non-corrodable material, each electrode being inserted in a respective electrode frame 38 comprising orifices 47 for circulation of fluids inside the electrodialysis unit,

single or plurivalent ion exchanger membranes 44, 45 having perforations so as to allow the circulation of fluids between the various layers, the membranes 44 being selected from cations or positive ions and the membranes 45 from anions or negative ions,

electrode and membrane separator frames 40 having a profile able to ensure the distribution of water exclusively to the surface of the electrodes 37, 37′ and the membranes 44, and

membrane separator frames 41 having a profile able to ensure the distribution of water to the surface of the membranes 44, 45, the position of these frames ensuring the distribution of water between the water circulation circuit of the water to be treated and the circuits where the purified and brackish water are respectively collected.

The external flanges 31, 31′ are for example constituted by polymer plates obtained by moulding or machining. They comprise in addition side perforations 36 allowing the passage of retention or locking elements, perforations 46 allowing the centering of the various elements of the treatment stage at the time the latter is assembled, and perforations 47 allowing the feeding and extraction of electrolytes. The flanges are fixed to one another so as to retain between them the various layers constituting the electrodialysis unit, these layers being sufficiently clamped against one another so as to obtain sufficient imperviousness between said layers.

The electrodes 37, 37′, having for example a rectangular shape and with a thickness of several millimetres, are constituted by a metal sheet coated with a precious metal. Preferably, these are constituted by titanium whose working face is coated with oxides of precious metals or precious metals such as platinum or gold. When the electrodialysis unit is in operation, the electrodes are polarised by the direct current.

The electrode frames 38 in which the electrodes 37, 37′ are respectively inserted are made of polymer or elastomer and have the same thickness as that of the electrodes. The rear face of the electrode 37 or 37′/electrode frame 38 unit is covered with an electrode rear face joint 39 formed of an elastic polymer film pierced at its centre so as to allow a portion of the rear face of the electrode 37, 37′ to appear and comprising other perforations needed for passage of the electrolytes.

The feeding of the electrodes (37) with d.c. current is effected by means of a copper wire covered with a sheath and uninsulated at its extremity which is in direct contact with the electrode. So as to obtain the required insulation and imperviousness, the sheath of the copper wire is welded or glued in the orifice 35 of the flange 31, 31′ which it traverses.

So as to ensure distribution of the water in the channels defined by the separator frames 40, 41 on the exchange surfaces of the membranes 44, 45, the separator frames, membranes, electrodes 37 and the flanges are stacked according to the following sequences.

In the case where the electrodialysis unit comprises a single treatment stage, it is constituted by the following sequence of layers:

Flange-joint-CE/E1-CSE-MC-CS1-MC-CS2-MC-CS1-MC-nx (CS2-MA-CS1-MC)-CS2-MC-CS1-MC-CS2-MC-CSE-E1/CE-joint-flange

in which:

CE/E1 or E1/CE is an assembling of the frame 38 and the electrode 37,

CSE is a separator frame 40,

MC is a cation exchanger membrane 44,

CS1 is a separator frame 41 in position 1,

CS2 is a separator frame 41 in position 2,

MA is an anion exchanger membrane 45, and

n is a whole value of, for example, between 1 and 150 for a domestic or public device.

The separator frames 41 is placed in two different positions CS1 and CS2 so as to define the channels for transferring fluids between the various layers corresponding to the desired circulation of fluids in the electrodialysis unit.

In the case where the electrodialysis unit comprises two treatment stages, it is constituted by the following sequence of layers:

Flange-joint-CE/E1-CSE-MC-CS1-MC-CS2-MC-CS1-MC-nx (CS2-MA-CS1-MC)-Ms-nx (CS2-MA-CS1-MC)-CS2-MC-CS1-MC-CS2-MC-CSE-E1/CE-joint-flange

in which Ms is a stage partition exchanger membrane which differs solely from the membranes 44, 45 concerning the position and presence of the fluid passage perforations through the various layers of the electrodialysis unit. In particular, the membrane Ms makes it possible to obtain a series connection instead of a parallel connection of the two stages.

It is to be noted that the near sequences of the electrodes are fixed, irrespective of the value of n.

It is to be noted that several cation exchanger membranes 44 MC have been successively placed following the electrodes before placing the anion exchanger membranes 45 MA. This disposition is able to limit the risk of precipitations on the membranes MA which is more greater close to the electrodes. Of course, in the case where the water to be treated is softer or less alkaline, this arrangement is not necessary.

The separator frames 40, 41 are embodied by operations for cutting and forming under compressive conditions a material appearing in the form of sheets or films. These cutting and forming operations are carried out so that the separator frame defines between two adjacent exchanger membranes 44, 45 a narrow channel 48, 48′, 48a which has been shaped so as to ensure a regular irrigation (at constant speed) by the water of the major part of the central portion of the surfaces of the membranes.

Having regard to the physico-chemical characteristics of the water to be treated, the thickness of the separator frames 40, 41 is extremely small, less than 1 mm and preferably between 0.1 and 0.6 mm, so as to minimise the ohmic drop between the electrodes 37 and thus the energy consumption. This characteristic also makes it possible to favour the additions of material to the surface of the ion exchanger membranes and thus increase the specific ion extraction efficiencies of the membranes.

On FIGS. 6 and 7, the separator frames 40, 41 have a square shape, the narrow channel 48, 48′, 48a having a sinuous shape so as to occupy the major part of the central portion of the surface of the separator frame.

On FIG. 7 which shows a separator frame 41, each of the two extremities of the channel 48, 48′ opens via a narrower linking section 53 onto water feed 52a and evacuation 52b orifices which communicate with the inlets 32 and outlets 33, 34, 34′ of the electrodialysis unit. The role of these narrower linking sections 53 is to maintain the surface evenness of the adjacent membranes 44, 45 in the region of the feed orifices 52a, 52b and thus to ensure imperviousness between the layers at this level.

The separator frame 41 further comprises two perforations 54a, 54b able to respectively define two other fluid transfer channels between the layers of the electrodialysis unit.

It is to be noted that for reasons of load loss level, the presence of linking sections 53 is only possible in the case of low flowrates corresponding to those required in domestic applications. In applications where a higher flowrate is required, it is necessary to provide other installations bringing about additional costs.

The frame 41 also includes two perforations 55a, 55b, also for the passage of fluids between the layers of the electrodialysis unit, and two perforations 46 allowing centering of the various layers of the electrodialysis unit when it is mounted. In fact, the frame 41 has been designed so as to be able to be used in the position shown on FIG. 6 and in the returned position, a single perforation 55a, 55b being used by each frame for transferring fluids between the layers.

The perforations 52a, 52b, 54a, 54b are formed in two opposing angles of the frame and have a shape so that the distance with the edge of the membrane is sufficient to ensure external imperviousness whilst offering a relatively large surface without limiting the exchange surface defined by the channel 48, 48′.

On FIG. 6, the separator frame 40 also includes perforations 46, 52a, 54a, 52b, 54b placed at the same locations as on the frame 41, and a channel 48a, 48b similar to that 48, 48′ of the frame 41 but which does not communicate with the perforations 52a or 54a and 52b or 54b and whose extremities coincide with the locations of the perforations 55a, 55b of the frame 41.

Generally speaking, the width of the channels 48, 48′, 48a, 48b of the frames 40, 41 is between several millimetres and 1 centimetre and preferably about 2.5 mm so as to ensure a good geometrical definition of the channel and avoid a collapse of the adjacent membranes 44, 45, the width of the narrower sections 53 of the frames 41 being between 1 and 2 mm. The length of the channel 48, 48′, 48a, 48b can vary between several centimetres and several metres.

On FIG. 8, the membranes (54, 55) also comprise perforations 46, 52a, 54a, 52b, 54b and 55a placed at the same locations as on the frames 40, 41.

Alternatively, the various layers of the electrodialysis unit can be circular. In this case, the separator frames 41′ can be embodied in the way shown on FIG. 9. This frame also includes a serpentine cut 48″ so as to delimit a sinuous channel with the two adjacent membranes 44, 45. As in the preceding embodiment, it comprises perforations 52a′ and 52b′ which communicate with the extremities of the cut 48″ for feeding and evacuating fluid in the channel delimited by the cut, two other perforations 54a′ and 54b′ making it possible to define a channel for the transfer of fluids with the other layers of the electrodialysis unit, and perforations 55a′ and 55b′ for defining yet another channel.

As shown diagrammatically on FIG. 5, the water to be treated is introduced through the inlet 32 in the channel 61 defined by the corresponding perforations 52a, 52b, 54a, 54b formed in the various layers of the electrodialysis unit 5 so as to disperse inside the separator frames 41 between the membranes 44, 45, but not in the electrode and membrane separator frames 40.

The perforations 52a, 52b, 54a, 54b made in the various layers of the electrodialysis unit (membranes 44, 45 and frames 40, 41) are embodied so as to define three channels 61, 62, 63 passing through the layers of the electrodialysis unit, namely a channel 61 formed of two contiguous perforations 52a, 52b or 54a, 54b for the distribution of the water to be treated in the membrane separator frames 41, and two channels 62, 63 for recovering the treated water and the brackish water at the outlet of the separator frames 41, the channel 62 being connected to the outlets of the channels 48, for example of odd sequence, and the channel 63 to the outlets of the channels 48′, for example of even sequence (see FIG. 5).

When a continuous electric field is applied to the water to be treated present in the frames 41 between the electrode 37, 37′, the anions are attracted by the positive electrode 37 (situated on the left on the figure), whereas the cations are attracted by the negative electrode 37′ (situated on the right on the figure). During this double inverted flow of ions and the passage of the water in the channels 48, 48′ formed by the separator frames 41, the ions become trapped in the channels 48′ of the separator frames 41 situated between the pairs of ion exchanger membranes of opposite adjacent signs, these pairs being constituted by a cation exchanger membrane 44 situated on the side of the electrode 37 and an anion exchanger membrane 45 situated on the side of the electrode 37′. In return, the water in the channels 48 of the separator frames 41 between the pairs of adjacent membranes constituted by an anion exchanger membrane 45 situated on the side of the electrode 37 and a cation exchanger membrane 44 situated on the side of the electrode 37′ is purified at the outlet of these channels. The brackish water is thus recovered at the outlet of the channels 48′ and removed towards the outlet 34 via the channel 62 and the purified water at the outlet of the channels 48 is collected in the channel 63.

According to one particular characteristic of the invention, the various layers (separator frames 40, 41 and membranes 44, 45) each includes a fourth perforation 55a, 55b making it possible to define a fourth channel 64 traversing these layers which open at its two extremities respectively into the channels 48a, 48b of the two electrode and membrane separator frames 40, the channel 63 being connected to the channel 48a of the membrane and electrode separator frame 40, situated against the anode 37, and the outlet of the channel 48b of the separator frame 40 situated against the electrode 37′ being connected to the purified water outlet 33 of the electrodialysis unit.

In this way, the purified water passes onto the two electrodes 37, 37′ before being sent to the outlet 33 of the electrodialysis unit.

The passage of the purified water onto the negative electrode 37′ makes it possible to reduce the precipitation phenomena on this electrode due in particular to the extremely weak acidity of the surrounding water. In fact, the passage of the purified water, which is more acid or less alkaline, makes it possible to increase the acidity of the water close to the electrode. Thus, a pretreatment for softening the water is avoided.

Moreover, the passage of the purified water onto the positive electrode 37 makes it possible to place this water in an oxidizing environment with a bactericidal effect resulting from the proximity of this electrode. Thus, a post-antibacterial treatment is avoided.

According to another characteristic of the invention, the polarity of the d.c. current applied to the electrodes is periodically inverted at an appropriate regular frequency. This arrangement avoids accumulation via successive precipitations of insoluble materials on the negatively polarised electrode and on the membranes.

The positive and negative alternances preferably are of the same duration which is adapted to the quality of the water to be treated and mainly to its calcium and magnesia hardness. This duration is preferably between several minutes and several tens of minutes and even better between two and ten minutes. In the same way, the quantities of d.c. current delivered to the system during the alternances are equal. These current quantity and direction values are determined so as to obtain a compromise between excessively short current quantities/durations which make it difficult to carry out an ionic separation of the purified water, and excessively long current quantities/durations which cause the formation by means of precipitation on the electrodes a relatively thick material layer which would tend to become detached by plates during the next alternance and thus to block the channels, especially 48, 48′ of the electrodialysis unit.

Advantageously, the precision of the equilibrium of the durations of the alternances and of those of the d.c. quantities delivered to the system are less than 1% and preferably less than ±0.05%.

This balancing of the period of the negative and positive alternances can be carried out by an extremely accurate digital counter which only counts the duration of the alternances during periods when the electrodialysis unit is switched on, whilst taking account of the duration of the alternance started at the time of the preceding switching off of the electrodialysis unit.

Moreover, the balance of the quantities of d. c. current delivered to the system during the polarity alternances requires the use of a d.c. power source delivering a constant intensity, said intensity able to be adjusted according to the characteristics of the water to be treated and the treated flow.

This polarity inversion involves the use of the double two-channel electrovalve 15, 16 shown on FIGS. 2 and 3, said valve being connected to the inlet 49 of the channel 48a and to the outlets 34, 34′ of the channels 62 and 63 shown on FIG. 5.

Depending on the polarity applied to the electrodes, the purified water is either located at the outlet 34 or the outlet 34′. If the purified water is at the outlet 34, the electrovalve 15 is controlled by the control element 9′, 9″ so as to send the purified water applied at the inlet into the joining pipe between the two electrovalves 15, 16 and connected to the inlet 49 of the electrodialyis unit 5. In the same way, the brackish water arrives via the outlet 34′ on the electrovalve 16 which is ordered by the control element 9′, 9″ so as to send the brackish water to the waste water evacuation circuit 8. During the next alternance, the purified water is located at the outlet 34′ and arrives on the electrovalve 16 which is controlled so as to send the purified water to the inlet 49, whereas the brackish water located at the outlet 34 is sent by the electrovalve 15 to the waste water evacuation circuit 8.

Advantageously, a slight offsetting is provided between the control moments of the electrovalves 15 and 16 so as to purge the circuit in which the brackish water passes by which the purified water will transit.

Of course, the inversion of the polarity of the electrodes 37, 37′ of the electrodialysis unit is not necessary if the water to be treated is not too hard or is previously softened. In this case, the device shown on FIG. 2 can be simplified in the way shown on FIG. 10. On this figure, the double electrovalve 15, 16 has been suppressed. The outlet 34′ is connected directly to the waste water evacuation circuit 8, whereas the outlet 34 is directly relooped onto the inlet 49. In the circuit upstream of the filter 4, it is also possible to replace the electrovalve 14 by a flowrate regulator 71. The entire device is controlled and fed with electric energy by a control element 90.

Similarly, in the case of the device shown on FIG. 1, it is possible to carry out a periodic cleaning/scaling using a dose of a food acid chemical agent introduced into the tank 1.

1. Device for purifying water for domestic and public usage, said device comprising an electrodialysis unit (5) including:
two flat electrodes (37, 37′) placed opposite each other and which are submitted to a d.c. voltage so as to generate between them a continuous electric field,
a plurality of ion exchanger membranes (44, 45) placed between the electrodes, amongst which some (44) being positive ions and the others (45) negative ions, and
a plurality of membrane separator frames (41), each placed between two adjacent ion exchanger membranes (44, 45) and allowing the passage of water along the surface of said two membranes,
two electrode and membrane separator frames (40) placed respectively between the two electrodes (37, 37′) and adjacent ion exchanger membranes (44) and allowing the passage of water along said electrodes,
a pipe (61) for distributing the water to be treated in the separator frames (41) and two respective pipes (62, 63) for extracting the brackish water and the purified water of the separator frames,
characterised in that the electrodialysis unit (5) comprises means to send the water to be treated exclusively into the separator frames (41) between two ion exchanger membranes, and means for sending the purified water of the purified water extraction pipe into the electrode and membrane separator frames (40) before sending it to the outlet (33) of the electrodialysis unit.

2. Device according to claim 1, characterised in that it comprises means (9′, 9″) to invert the polarity applied to the electrodes (37, 37′) and to periodically control the inversion polarity so that the respective periods of the positive polarisation alternances and negative polarisation alternances are equal, and/or so that the amount of the d.c. current delivered to the system during each alternance are equal, and electrovalve means (15, 16) switched to each alternance so as to direct the extracted brackish water to the brackish water outlet (34) of the electrodialysis unit (5) and the purified water in the electrode and membrane separator frames (40) and then towards the purified water outlet (33) of the electrodialysis unit.

3. Device according to claim 2, characterised in that the duration of the polarity alternances is between several minutes and ten minutes and preferably between two and ten minutes.

4. Device according to claim 2, characterised in that the equality of duration of the polarity alternances and/or the quantity of the d.c. current delivered to the system is/are obtained with an accuracy of less than ±1% and preferably less than ±0.05%.

5. Device according to one of the preceding claims, characterised in that it includes a pre-treatment unit (4) placed upstream of the electrodialysis unit (5) and adapted to the physio-chemical quality of the water to be treated.

6. Device according to one of the preceding claims, characterised in that it consists of a small household device comprising a box, a tank (1) for the water to be treated at atmospheric pressure, a pump (3) connected to the outlet of the tank (1) to send the water to be treated to the electrodialysis unit (5), a purified water tank (6) at atmospheric pressure connected to the purified water outlet (33) of the electrodialysis unit, and a control and electric supply element (9) for controlling the pump (3) and the electrodialysis unit (5) according to the level of the water to be treated present in the tank (1).

7. Device according to claim 6, characterised in that the purified water tank (6) is movable.

8. Device according to one of claims 1 to 5, characterised in that the electrodialysis unit (5) is connected to an under-pressure water distribution circuit (12) by means of an electrovalve (14), the outlet (33) of the purified water of the electrodialysis unit being connected to a an under-pressure tank (19) making it possible to distribute the water under pressure on demands, said device comprising a control element (9′) automatically controlling the electrodialysis unit (5) according to the pressure detected in the purified water circuit.

9. Device according to one of the preceding claims, characterised in that each separator frame (40, 41) has the shape of a plate less than 1 mm thick and comprising a sinuous cut having the shape of a serpentine so as to define with the membranes (44, 45), or the electrode (37, 37′) and the membrane (44, 45) between which it is supported, a channel (48) at whose inlet the water to be treated is injected, the shape of said cut being such that it extends onto the major part of the central portion of the separator frame.

10. Device according to one of the preceding claims, characterised in that the electrodialysis unit (5) comprises two flanges (31, 31′) between which a plurality of layers are squeezed successively constituted starting from each flange an electrode (37, 37′), an electrode and membrane separator frame (40), a selective positive ion exchanger membrane (44), followed by a plurality of membrane separator frames (41 alternately placed with the membranes (44, 45), all these layers being provided with perforations arranged in such a way as to define at least three channels, namely a channel (61) for distributing the water to be treated in the membrane separator frames (41), a channel (62) for recovering the fluid at the outlet of the membrane separator frames (41) situated between a selected positive ion membrane in a first direction perpendicular to the planes of the electrodes, and a selected negative ion membrane in a second opposite direction, and a channel (63) for recovering the fluid at the outlet of the membrane separator frames (41) situated between a negative ion selective membrane in the first direction, and a positive ion selective membrane in the second direction.

11. Device according to claim 10, characterised in that all the layers of the electrodialysis unit (5) situated between the flanges (31, 31′) comprise in addition perforations (55a, 55b) placed so as to define a fourth channel (64) making it possible to connect between them the two electrode and membrane separator frames (40).
